(19) United States
(12) Patent Application Publication
(10) Pub. No.: US 2014/0137038 A1
(43) Pub. Date: May 15, 2014

(54) ELECTRONIC APPARATUS AND METHOD OF DISPLAYING A USER INPUT MENU

(71) Applicant: Seungman Kim, McLean, VA (US)

(72) Inventor: Seungman Kim, McLean, VA (US)

(73) Assignee: Seungman Kim, McLean, VA (US)

(21) Appl. No.: 13/673,991

(22) Filed: Nov. 10, 2012

(51) Int. Cl. G06F 3/0482

(52) U.S. Cl. CPC G06F 3/0482
USPC 715/810

(57) ABSTRACT

An electronic apparatus includes a display unit having a screen to display a screen image with a user input menu, a detecting unit to detect a rotation of the apparatus, and a control unit to adjust the screen image to include the user input menu disposed in a distance from a side of the screen of the display unit according to the detected rotation of the apparatus.

### BACKGROUND OF THE INVENTIVE CONCEPT

1. Field of the Inventive Concept

The present inventive concept relates to an electronic apparatus and method of displaying a user input menu in a touch panel of a display unit thereof.

2. Description of the Related Art

A conventional electronic apparatus, for example, a computer apparatus or a mobile apparatus, displays a user input menu on a screen image of a touch panel of a display unit thereof. When the apparatus rotates, the screen image rotates according to the rotation of the apparatus, and the user input menu is changed according to the rotation of the screen image and disposed a location where a user finger cannot reach while a user hand supports the apparatus. It is very inconvenient for a user to select or touch the user input menu when the user input menu is located at a distant location away from a user hand or disposed at a distance longer than a user finger from a side of the apparatus.

Also it is very inconvenient for a user who has to support the apparatus and select or touch the user input menu with one hand. However, the user input menu disposed within a distance where a user finger reaches is changed to another position of the screen image where a user finger cannot reach according to a rotation of the apparatus.

### SUMMARY OF THE INVENTIVE CONCEPT

The present inventive concept provides an electronic apparatus to display a user input menu at a location where a user finger can reach.

The present inventive concept provides a method of displaying a user input menu at a location where a user finger can reach.

The present inventive concept provides a computer readable medium to contain computer readable codes as a program to execute a method of displaying a user input menu at a location where a user finger can reach.

Additional features and utilities of the present inventive concept will be set forth in part in the description, which follows and, in part, will be obvious from the description, or may be learned by practice of the present inventive concept.

The foregoing and/or other features and utilities of the present inventive concept may be achieved by providing an electronic apparatus including a display unit having a screen to display a screen image with a user input menu, a detecting unit to detect a rotation of the apparatus, and a control unit to adjust the screen image to include the user input menu disposed in a distance from a side of the screen of the display unit according to the detected rotation of the apparatus.

The foregoing and/or other features and utilities of the present inventive concept may also be achieved by providing an electronic apparatus including a display unit having a screen to display a screen image with a user input menu section with one or more user input menus to enter a user input to control one of the screen image and the electronic apparatus, and a control unit to control the user input menu section of the screen image to be disposed closer to one side of the screen of the display unit than the other opposite side of the screen of the display unit.

The control unit may control the screen image to be adjusted according to a rotation of the electronic apparatus.

The electronic apparatus may include a detecting unit to detect the rotation of the electronic apparatus, and the control unit may arrange the user input menus to be disposed closer to the one side than the other opposite side of the screen according to the detected rotation of the electronic apparatus.

The control may detect a user input and may arrange the user input menus to be disposed closer to the one side than the other opposite side of the screen according to the detected rotation of the electronic apparatus.

The electronic apparatus may include a housing having first opposite sides having a first length and second opposite sides having a second length, and the control unit may control the user input menu section of the screen image to be disposed closer to one of the first opposite sides and the second opposite sides than the other one of the first opposite sides and the second opposite sides.

The electronic apparatus may include a housing having first opposite sides having a first length and second opposite sides having a second length shorter than the first length, the control unit may control the user input menu section of the screen image to be disposed closer to one of the second opposite sides than the other one of the second opposite sides.

The electronic apparatus may include a housing having first opposite sides having a first length and second opposite sides having a second length, the screen image may include a non-user input menu section having one or more non-user input menus, and the control unit may not control the non-user input menu section to be disposed closer to any of the first opposite sides and the second opposite sides.

The electronic apparatus may include a housing having first opposite sides having a first length and second opposite sides having a second length, the screen image may include a main menu section having one or more main menus to receive a user input, and the control unit controls the main menu section to be disposed to closer to one of the first opposite sides and the second opposite sides.

The electronic apparatus may further include a housing having first opposite sides having a first length and second opposite sides having a second length shorter than the first length, the screen disposed on the housing, and the control unit may control the user input menu section to be disposed within a distance to correspond to the second length regardless of a rotation of the electronic apparatus.

The electronic apparatus may include a housing having first opposite sides having a first length and second opposite sides having a second length shorter than the first length, the screen image may include a main menu section having an image and a play button, and the control unit may control the play button of the main menu section to be disposed to closer to one of the first opposite sides and the second opposite sides to control the image of the main menu section.

The foregoing and/or other features and utilities of the present inventive concept may also be achieved by providing a method usable with electronic apparatus, the method including displaying a screen image with a user input menu in a screen of a display unit, detecting a rotation of the apparatus, and adjusting the screen image to include the user input menu disposed in a distance from a side of the screen of the display unit according to the detected rotation of the apparatus.

The foregoing and/or other features and utilities of the present inventive concept may also be achieved by providing a method usable with electronic apparatus, the method including controlling a display unit having a screen to display a screen image with a user input menu section with one or more user input menus to enter a user input to control one of the screen image and the electronic apparatus, and controlling the user input menu section of the screen image to be disposed closer to one side of the screen of the display unit than the other opposite side of the screen of the display unit.

The controlling of the user input menu section may include detecting a rotation of the electronic apparatus, and arranging the user input menus to be disposed closer to the one side than the other opposite side of the screen according to the detected rotation of the electronic apparatus.

The controlling of the user input menus section may include detecting a user input and arranging the user input menus to be disposed closer to the one side than the other opposite side of the screen according to the detected rotation of the electronic apparatus.

The electronic apparatus may include a housing having first opposite sides having a first length and second opposite sides having a second length. The controlling may include controlling the user input menu section of the screen image to be disposed closer to one of the first opposite sides and the second opposite sides than the other one of the first opposite sides and the second opposite sides.

The electronic apparatus may include a housing having first opposite sides having a first length and second opposite sides having a second length shorter than the first length. The controlling may include controlling the user input menu section of the screen image to be disposed closer to one of the second opposite sides than the other one of the second opposite sides.

The screen image may include a non-user input menu section having one or more non-user input menus, and the controlling may include controlling the non-user input menu section to be disposed closer to any of the first opposite sides and the second opposite sides.

The screen image may include a main menu section having one or more main menus to receive a user input. The controlling may include controlling the main menu section to be disposed to closer to one of the first opposite sides and the second opposite sides.

The controlling may include controlling the user input menu section to be disposed within a distance to correspond to the second length regardless of a rotation of the electronic apparatus.

The screen image may include a main menu section having an image and a play button. The controlling may include controlling the play button of the main menu section to be disposed to closer to one of the first opposite sides and the second opposite sides to control the image of the main menu section

The foregoing and/or other features and utilities of the present inventive concept may also be achieved by providing a computer-readable medium to contain computer-readable codes as a program to execute a method usable with electronic apparatus, the method including displaying a screen image with a user input menu in a screen of a display unit, detecting a rotation of the apparatus, and adjusting the screen image to include the user input menu disposed in a distance from a side of the screen of the display unit according to the detected rotation of the apparatus.

The foregoing and/or other features and utilities of the present inventive concept may also be achieved by providing a computer-readable medium to contain computer-readable codes as a program to execute a method of controlling an electronic apparatus including controlling a display unit having a screen to display a screen image with a user input menu section with one or more user input menus to enter a user input to control one of the screen image and the electronic apparatus, and controlling the user input menu section of the screen image to be disposed closer to one side of the screen of the display unit than the other opposite side of the screen of the display unit.

### BRIEF DESCRIPTION OF THE DRAWINGS

These and/or other features and utilities of the present general inventive concept will become apparent and more readily appreciated from the following description of the exemplary embodiments, taken in conjunction with the accompanying drawings of which:

FIGS. 1A through 1G are views illustrating an electronic apparatus to display a screen image with a user input menu within a screen of a display unit in response to a rotation of the electronic apparatus according to an embodiment of the present inventive concept;

FIGS. 2A, 2B, and 2C are views illustrating an electronic apparatus to display a sub-screen image with a user input menu within a screen of a display unit in response to a rotation of the electronic apparatus according to an embodiment of the present inventive concept;

FIG. 3 is a block diagram illustrating an electronic apparatus to display a screen image with a user input menu within a screen of a display unit in response to a rotation of the electronic apparatus according to an embodiment of the present inventive concept;

FIG. 4 is a flowchart illustrating a method of displaying a screen image with a user input menu within a screen of a display unit in response to a rotation of the electronic apparatus according to an embodiment of the present inventive concept;

FIGS. 5A, 5B, and 5C are views illustrating a menu to set a display method of displaying a user input menu in a screen image of a screen of a display unit according to an embodiment of the present inventive concept;

FIGS. 6A and 6B are perspective views illustrating an electronic apparatus to detect a rotation thereof with respect to a reference plane according to an embodiment of the present inventive concept

FIGS. 7A and 7B are views illustrating an electronic apparatus to adjust a user input menu within a screen of a display unit according to an embodiment of the present inventive concept;

FIGS. 8A and 8B are views illustrating an electronic apparatus to adjust a user input menu within a screen of a display unit according to an embodiment of the present inventive concept;

FIGS. 9A, 9B, and 9C are views illustrating an electronic apparatus to adjust a user input menu within a screen of a display unit according to an embodiment of the present inventive concept;

FIGS. 10A and 10B are views illustrating an electronic apparatus to adjust a user input menu within a screen of a display unit according to an embodiment of the present inventive concept; and

FIGS. 11A and 11B are views illustrating an electronic apparatus to display another user input menu within a screen of a display unit according to an embodiment of the present inventive concept.

### DETAILED DESCRIPTION OF THE EXEMPLARY EMBODIMENTS

Reference will now be made in detail to exemplary embodiments of the present general inventive concept, examples of which are illustrated in the accompanying drawings, wherein like reference numerals refer to the like elements throughout. The exemplary embodiments are described below in order to explain the present general inventive concept while referring to the figures.

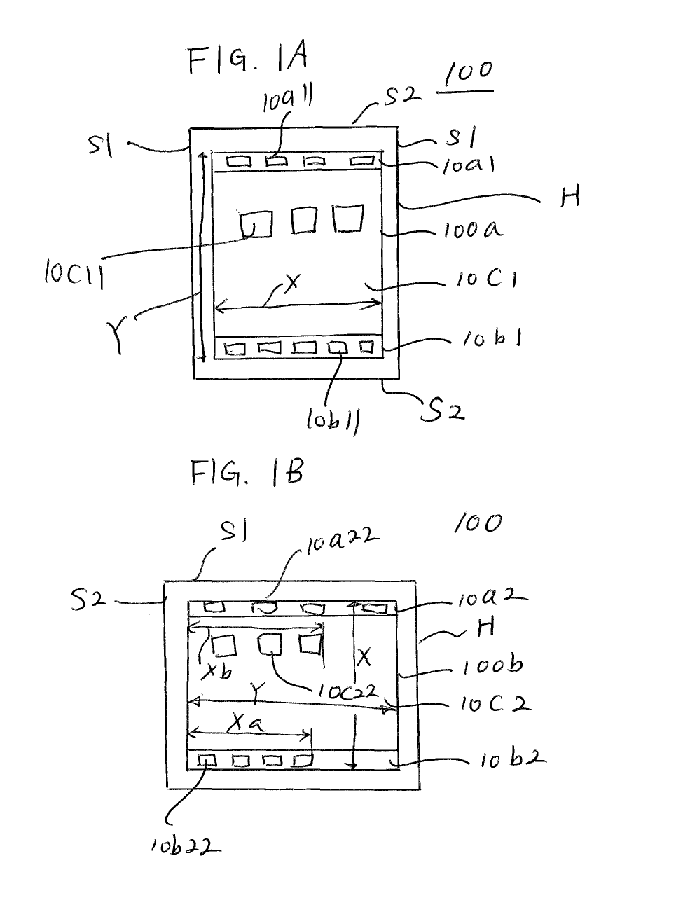

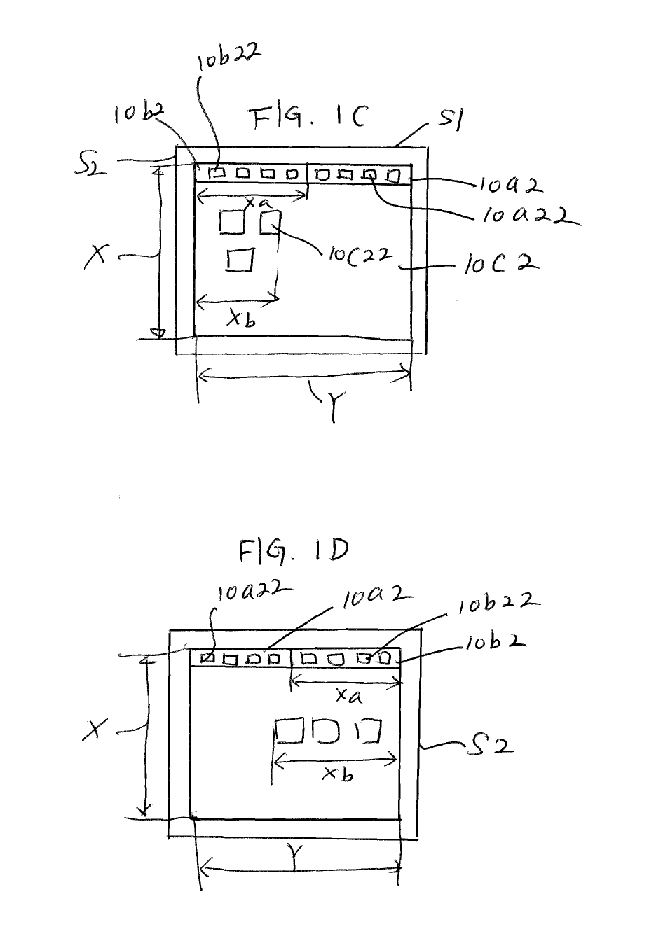

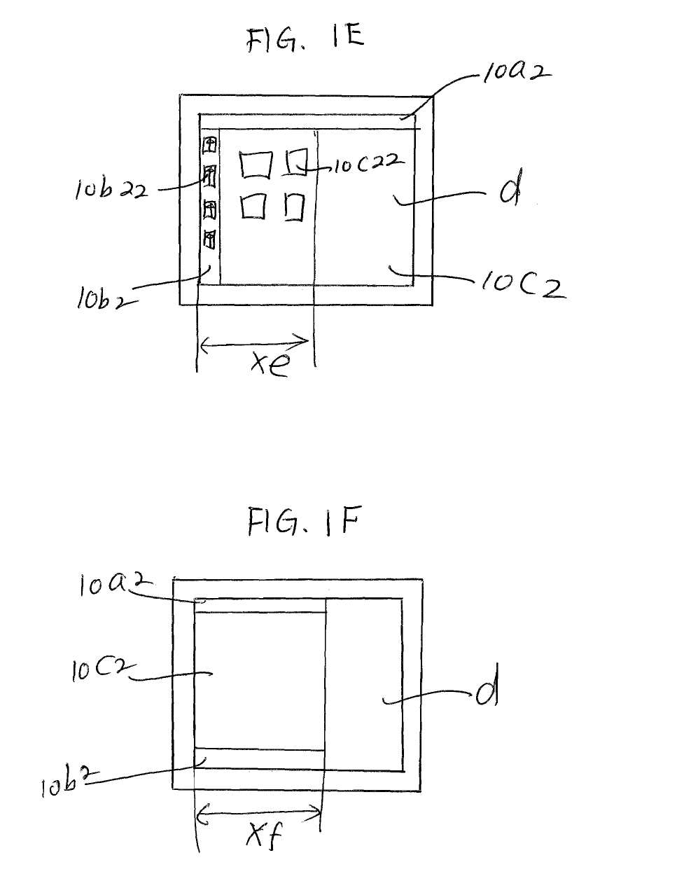

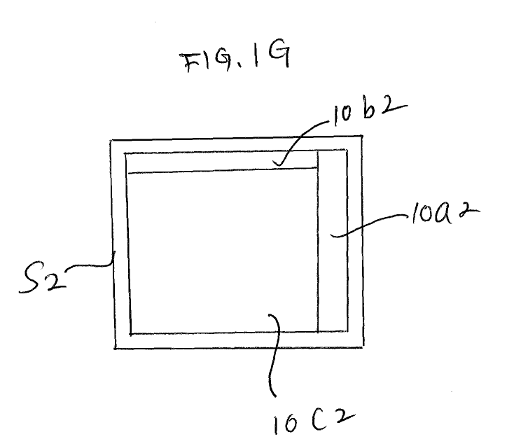

FIGS. 1A and 1B illustrate an electronic apparatus 100 according to an embodiment of the present inventive concept. The electronic apparatus 100 may be a computer apparatus, a portable personal computer, a mobile device, a mobile phone, a mobile tablet apparatus, a mobile tablet computing apparatus, an audio or video recording and/or reproducing apparatus, a photographing apparatus, a communication device, etc.

The electronic apparatus 100 may have a housing H having different sides S1 and S2. The different sides S1 and S2 may have different lengths. Here, the side S1 has a length longer than side S2. The electronic apparatus 100 may be a mobile device, a tablet computer device, or a wireless communication device, such as a cell phone or a hand held phone. When a user supports the electronic apparatus 100 at one side S1 with one hand, the length of the side S2 may correspond to a distance such that a user finger tip (or a tip of a user thumb) of the one hand can reach the other side S1 as illustrated in FIG. 1A.

However, when a user supports the electronic apparatus 100 at one side S2 with one hand, the length of the side S1 may be longer than a distance such that a user finger tip (or a tip of a ser thumb) of the one hand cannot reach the other side S2 as illustrated in FIG. 1B.

The electronic apparatus 100 may have a display unit having a touch panel to display a screen image with a user input menu to receive a user input. The display unit may have a screen having a length Y to correspond to the side S1 and a length X to correspond to the side S2. Here, the length Y may be longer than the length X as illustrated in FIG. 1A.

FIG. 1A illustrates a first position of the electronic apparatus 100. A screen 100a of FIG. 1A may include a non-user input menu section 10a1 to display one or more non-user input menus 10a11, a user input menu section 10b1 to display one or more user-input menus 10b11 to receive a corresponding user input, and a main menu section 10c1 to display one or more main menus 10c11 and/or receive a corresponding user input from the one or more main menus 10c11.

The non-user input menus 10a11 may be a time display, a battery state display, a wireless carrier display, a wireless signal strength display, a current state of the electronic apparatus 100, for example. The non-user user menus 10a11 may be display items which do not require a user input or may be display items through which a user cannot input a user input to the electronic apparatus 100 by touching a corresponding menu.

The main menus 10c11 may be icons, for example, an application icon, a home screen menu icon, etc. The main menus 10c11 are also user-input menus so that a user can enter a user input to the electronic apparatus 100 by touching a corresponding menu.

The user input menus 10b11 may be icons, for example, user-predetermined icons, specific icons selectable from the main menus 10c11. The user input menus 10b11 may be a telephone icon, a email icon, an Internet navigation icon, etc. A user can enter a user input to the electronic apparatus 100 by touching a corresponding user-input menu 10b11.

When a user enters a user input by touching or selecting one of the main menus 10c11 and the user input menus 10b11, the screen 100a may be changed to a sub-screen image according to execution of the selected one of the main menus 10c11 and the user input menus 10b11. The sub-screen may not include the main menu section 10c1 and/or the user input menu section 10b1. The sub-screen may include the non-user input menu section 10a1. The sub-screen may include a section to display an image to perform the selected menu 10c11 or 10b11.

The screen 100a may include one or more pages of screens. Each page screen may include the non-user input menu section 10a1 and the user input menu section 10b1. The non-user input menu section 10a1 and/or the user input menu section 10b1 may be repeatedly displayed on all screens. The non-user input menu section 10a1 and/or the user input menu section 10b1 may be repeatedly displayed on all screens at the same locations. It is possible that The non-user input menu section 10a1 and/or the user input menu section 10b1 may be repeatedly displayed on all screens at different locations. Each page screen may include the main menu section 10c1 with different icons from icons of other page screen.

The non-user input menu section 10a1 and/or the user input menu section 10b1 may not be modified by a user. The non-user input menu section 10a1 and/or the user input menu section 10b1 may be a menu section which is not deleted or changed. The main menus 10c11 may be added or deleted by a user preference. The number of menu icons 10c11 of the main menu section 10c1 may be changed according to a user setting, selection or preference.

FIG. 1B illustrates a second position of the electronic apparatus 100. The second position rotates with respect to the first position by a certain angle, for example, a right angle or about 90 degrees. The screen 100b of FIG. 1B may include a non-user input menu section 10a2 to display one or more non-user input menus 10a22, a user input menu section 10b2 to display one or more user-input menus 10b22 to receive a corresponding user input from the one or more user-input menus 10b22, and a main menu section 10c2 to display one or more main menus 10c22 and/or receive a corresponding user input from the one or more main menus 10c22.

In the screen 100b of FIG. 1B, the non-user input menu section 10a2 may have a length to correspond to the length Y, however, the user input menu section 10b2 may have a length Xa. The length Xa may correspond to a length X. The length Xa may shorter than the length X. It is possible that the length Xa may be the same as the length of the side S2. However, the present inventive concept is not limited thereto. The length Xa may be a length between the length X and the length Y. The length Xa may be shorter than the length Y of the screen 100a or 100b.

Also, in the screen 100b of FIG. 1 B, the main menu section 10c2 may have a length Xb. The length Xb may correspond to a length X. The length Xb may shorter than the length X. It is possible that the length Xb may be the same as the length of the side S2. However, the present inventive concept is not limited thereto. The length Xb may be a length between the length X and the length Y. The length Xb may be shorter than the length Y of the screen 100a or 100b. It is possible that the length Xb may be longer than the length Xa.

The menus 10b22 and 10c22 may be arranged to be disposed within the length Xa and Xb from one side of the screen 100b corresponding to the side S2.

When the electronic apparatus 100 rotates from the first position of FIG. 1A to the second position of FIG. 1B, the user input menus 10b22 are arranged and displayed at a distance such that a user finger tip can reach all of the user input menus 10b22 from the side S2. When the user input menus 10b22 are disposed throughout the length Y, a user finger tip may not reach at least one of the user input menus 10b22 when one user hand supports the apparatus 100 in the second position of FIG. 1 B. Since the user input menus 10b22 are not disposed throughout the length Y, a user finger tip of a user hand may reach the user input menus 10b22 with the user hand supporting the apparatus 100 in the second position of FIG. 1B, without using the other hand finger.

Since the non-user input menu section 10a2 does not receive a user input, the non-user input menus 10a22 of the non-user input menu section 10a2 may be disposed throughout the length Y.

The screen 100a may have ratios and/or arrangements among the non-user menu section 10a1, the main menu section 10c1, and the user input menu section 10b1 in dimension, size, location, or characteristics, for example, color, etc. The screen 100b may have ratios and/or arrangements different from those of the screen 100a.

Referring to FIG. 1C, the user input menu section 10b2 and the non-user input menu section 10a2 are arranged in order from the side S2. The user input menu section 10b2 is disposed to be closer to a user hand supporting the electronic apparatus 100 than the non-user input menu 10a2. Since the user input menu section 10b2 has the length Xa, a length of the non-user input menu may be Y-Xa. The main menu section 10c2 may have a length Xb.

FIG. 1C illustrates the electronic apparatus 100 supported by a right side hand of a user, and FIG. 1D illustrates the electronic apparatus 100 supported by a left side hand of a user.

Referring to FIG. 1E, the user input menu section 10b2 is arranged and disposed along the side S2 and has a length to correspond to the length X. The user input menu section 10b2 may be disposed closer to the side S2 than the main menu section 10C2. The main menus 10c22 may be disposed within a length Xe from the side S2. The length Xe may be between the length Y and the length X. It is possible that the length Xe may be same as the length X.

Referring to FIG. 1F, the non-user menu section 10a2, the main menu section 10c2, and the user input menu section 10b2 are disposed within a length Xf from the side S2. The length Xf may be between the length Y and the length X. It is possible that the length Xf may be same as the length X.

Referring to FIGS. 1E and 1F, the screen may have a space d as a reserved space so that the user can use the space d to display information which can be defined by a user. The information may be status of the electronic apparatus 100, a user schedule, or an upcoming event, for example.

Referring to FIG. 1G, the user input menu section 10b2 and the main menu section 10c2 are disposed within a distance from the side S2, and the non-user input menu section 10a2 is disposed away from the side S2 more than the user input menu section 10b2 and the main menu section 10c2.

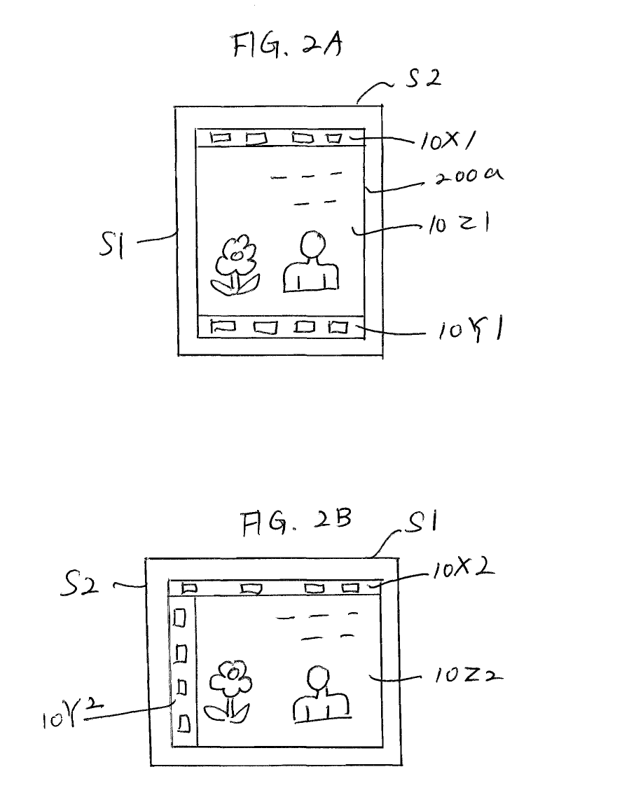

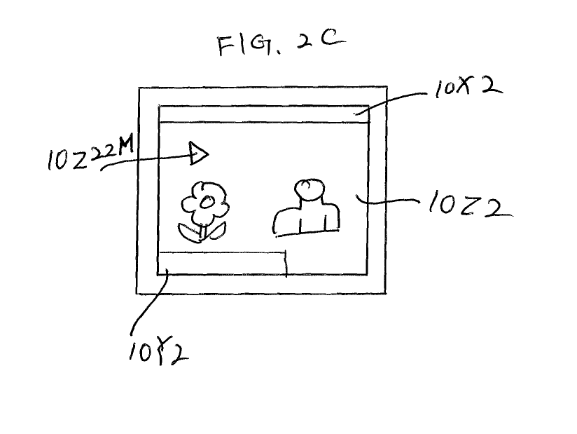

When one of the menus of FIGS. 1A-1G is selected or touched, the screen 100a or 100b is changed to an execution screen to perform a function of the selected menu or to execute the selected menu, for example, a sub screen 200a of FIG. 2A or a sub screen 200b of FIG. 2B. The sub screen 200a can be changed to the sub screen 200b or the sub screen 200b can be changed to the sub screen 200a, according to a rotation of the electronic apparatus 100.

The sub screen 200a of FIG. 2A may include a non-user input menu section 10x1, a user input menu section 10y1, and an execution section 10z1. The sub screen 200b of FIG. 2B may include a non-user input menu section 10x2, a user input menu section 10y2, and an execution section 10z2. FIGS. 2A and 2B illustrate sides S1 and S2 of the electronic apparatus 100 as a supporting portion which may be supported by a user hand.

The non-user input menu section 10x1or 10x2 may be same as the non-user input menu section 10a1 or 10a2 of FIG. 1A-1G. However, it is possible that the non-user input menu section 10x1 or 10x2 and the non-user input menu section 10a1 or 10a2 can be different from each other by adding, deleting, or modifying the corresponding non-user input menu. It is also possible that at least one of the non-user input menus 10a11 or 10a22 of the non-user input menu section 10a1 or 10a2 is not included in the non-user input menu section 10x1 or 10x2. It is also possible that a new non-user input menu can be added to the non-user input menu section 10x1 or 10x2.

The user input menu section 10y1 or 10y2 may be different from the user input menu section 10b1 or 10b2. The user input menu section 10y1 or 10y2 may include menus to control the execution section 10z1 or 10z2.

The execution section 10z1 or 10z2 may be an image as a portion generated during execution of the selected menu or during performing a function of the selected menu. The execution section 10z1 or 10z2 may be generated when one of menus of the main menu section 10a1 or 10a2 and menus of the user input menu section 10b1 or 10b2 is selected or touched by a user. The execution section 10z1 or 10z2 may be controlled by a user to touch or select one menu of the user menu section 10y1 or 10y2. The execution section 10z1 or 10z2 may include a moving or still image display, a text message display, a keyboard display, a character or symbol display, a photographing function display, etc., generated when the function of the corresponding menu is executed or performed.

The screens 200a and 200b may be changed in same ways as the screens 100a and 100b of FIGS. 1A-1G according to a rotation of the electronic apparatus 100.

Referring to FIG. 2C, when the screens 200a and 200b are a screen to display a motion picture or a movie, a play menu icon or menu button 10Z22M can be disposed in the main menu section 10Z2 closer to the left side S2 than the right side S2 or a left screen side that a right screen side so that a user can touch or select the play menu icon or menu button with a user hand which support the electronic apparatus. In this case, a user does not have to put down the electronic apparatus or use the other hand to select or touch the play menu icon or menu button 10Z22M.

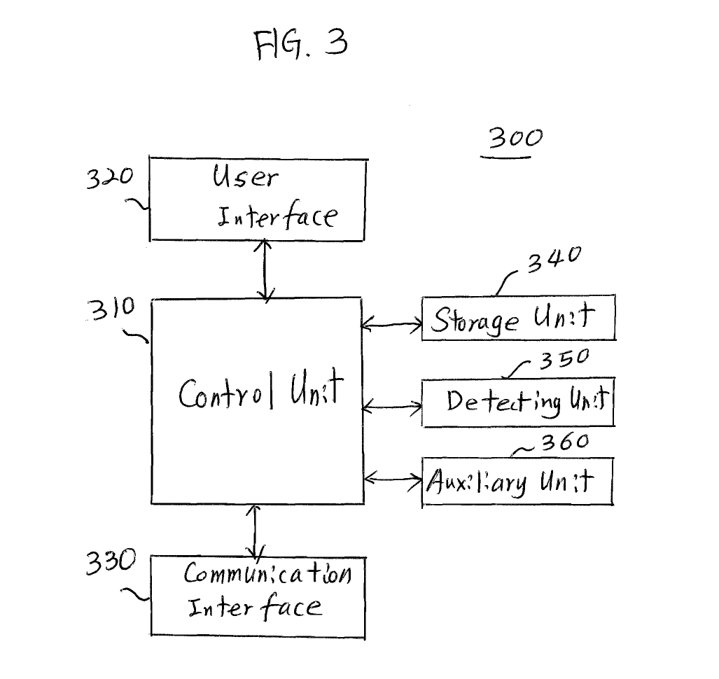

FIG. 3 is a block diagram illustrating an electronic apparatus 300 to display a screen image with a user input menu within a screen of a display unit in response to a rotation of the electronic apparatus according to an embodiment of the present inventive concept. The electronic apparatus 300 may display a screen image with a user input menu within a screen of a display unit in response to a rotation of the electronic apparatus. The electronic apparatus 300 may be the same as the electronic apparatus 100 illustrated in FIGS. 1A-2B.

The electronic apparatus 300 may include a control unit 310, a user interface unit 320, a communication interface unit 330, a storage unit 340, a detecting unit 350, and an auxiliary unit 360.

The communication interface unit 330 may be connected to an external device through a weird or wireless communication method to transmit or receive data corresponding to a function of the electronic apparatus 300.

The control unit 310 may control the user interface unit 320, the communication interface unit 330, the storage unit 340, the detecting unit 350, and the auxiliary unit 360 to perform functions of the electronic user interface unit 320. The control unit may include a functional unit, for example, an audio or video processing unit or a data processing unit to process data to generate a signal corresponding to an image to be displayed on a screen and/or sound to be generated through an audio unit. The functional unit may be included in the user interface unit 320. The functional unit may be a unit to process a user input and to perform a function according to the user input. The functional unit may have an electrical portion and/or a mechanical portion to perform a function of the electronic apparatus 300.

The user interface unit 320 may include a display unit having a touch panel to form a screen to display an image and to receive a user input. The user interface unit 320 may include an audio unit including a speaker unit to generate sound corresponding to a signal generated from the functional unit. The audio unit may be installed on the display unit. The audio unit may be one or more terminals to be connected to a corresponding external speaker to generate the sound.

The user interface unit 320 may include an input unit, for example, a button or a switch to control a function of the electronic apparatus 100 or select a function of the electronic apparatus 100. The input unit may be an input unit of a touch panel of the display unit to input a user input including a user command or user data to the functional unit. The input unit may be a control input unit to control one or more units of the electronic apparatus 300.

The storage unit 340 may be a storage to receive data and store the received data. The storage unit 150 may be a storage to store a program to initiate or operate the electronic apparatus 300.

The detecting unit 350 detects a rotation of the electronic apparatus 300 to correspond to the screen 100a, 100b, 200a, and 200b of FIGS. 1A-2B. The detecting unit 350 may be a sensor to detect a position or a rotation with respect to a reference, for example, two or three axis coordinates. According to a detected signal of the detecting unit 350, a screen of the electronic apparatus 300 can be changed to the screens 100a, 100b, 200a, and 200b as illustrated in FIGS. 1A-2B. The detecting unit 350 may be included in the user interface unit 320 as a menu to generate a signal to correspond to the detected signal indicating a rotation of the electronic apparatus.

The auxiliary unit 360 may be a bundle to be implemented into the electronic apparatus to perform a function thereof. The control unit 310 may control the existing units to include an icon or menu of the bundle in the screen 100a, 100b, 200a, or 200b. It is possible that the auxiliary unit 360 may be an external apparatus connectable to the electronic apparatus 300 to control, change, modify, or delete data to be stored or processed in the electronic apparatus 300. The auxiliary unit 360 may be a personal computer connectable the electronic apparatus 300 to reproduce a video image or a sound signal to the user interface unit 320.

The control unit 160 may control the user interface unit 320 to generate the screen 100a, 100b, 200a, or 200b according to a rotation of the electronic apparatus 300.

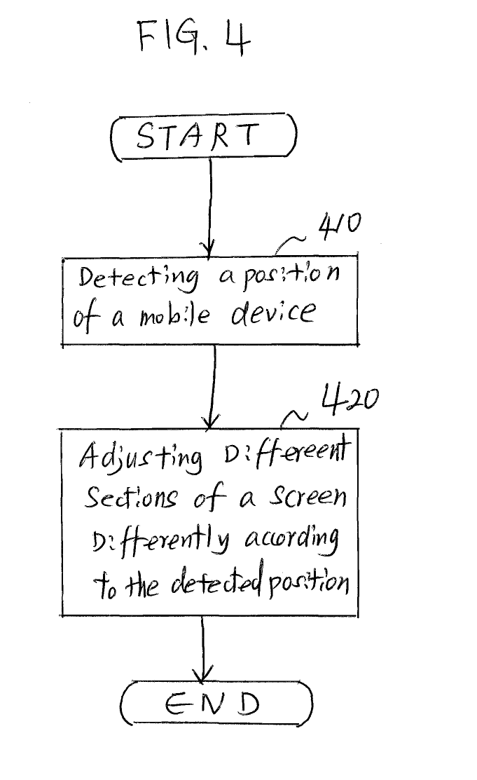

FIG. 4 is a flowchart illustrating a method of the electronic apparatus 100 or 300 according to an embodiment of the present inventive concept. The method may include displaying a screen image with a user input menu within a screen of a display unit in response to a rotation of the electronic apparatus 100 or 300.

The method includes detecting a position (rotation) of a mobile device at operation 410, and adjusting different portions or sections of a screen differently according to the position (rotation) of the mobile device at operation 420.

The detecting may include detecting the position (rotation) with respect to a reference plane or direction. The detecting may include selecting an icon or menu displayed in a section of a screen 10 as the position (rotation) of the electronic apparatus 300.

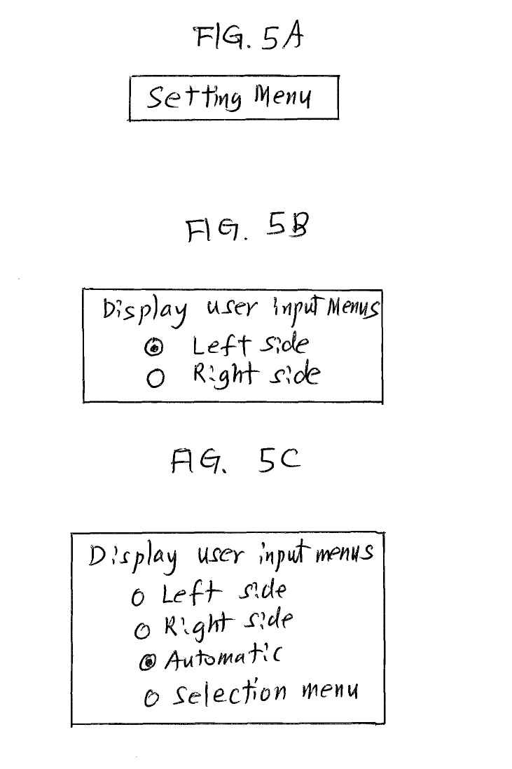

Referring to FIG. 5A, a menu to set a screen as the screen 100a, 100b, 300a, and 300b can be included in the main menu section 10c1 or 10c2 of FIGS. 1A and 1B. In FIG. 5B, when the setting menu of FIG. 5A is touched or selected, a second menu is displayed to select a left side or a right side to place the user input section closer to the selected side. In FIG. 5C, a third menu may be displayed to select a left side, a right side, an automatic sensing, and/or a user selection input. The left side and the right side may be selected according to a user preference when a rotation of the electronic apparatus 300 is detected or selected. The automatic sensing and/or the user selection input may be selected to sense the rotation of the electronic apparatus 300 using a sensor or to select or input a user input to correspond to the rotation of the electronic apparatus 300 using an icon or menu of a screen thereof.

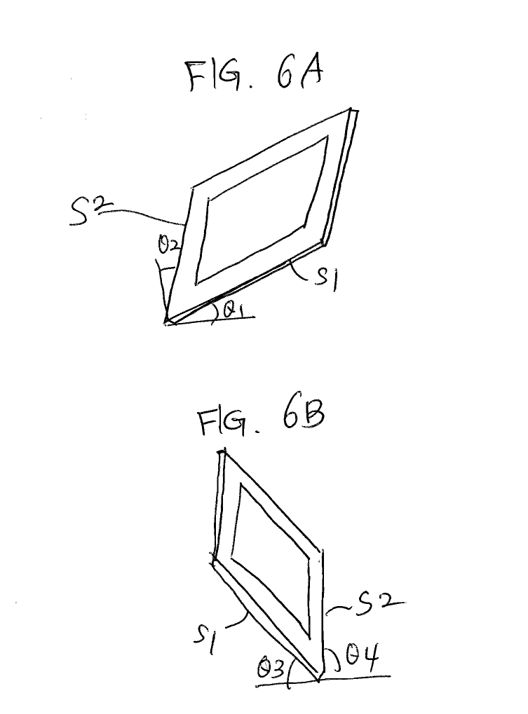

FIG. 6 illustrates a position or rotation of the electronic apparatus to form angles θ1, θ2, θ3, and θ4 with respect to reference planes to change the screens 100a and 100b or the screens 300a and 300b or place the user input menus closer to the left side or right side.

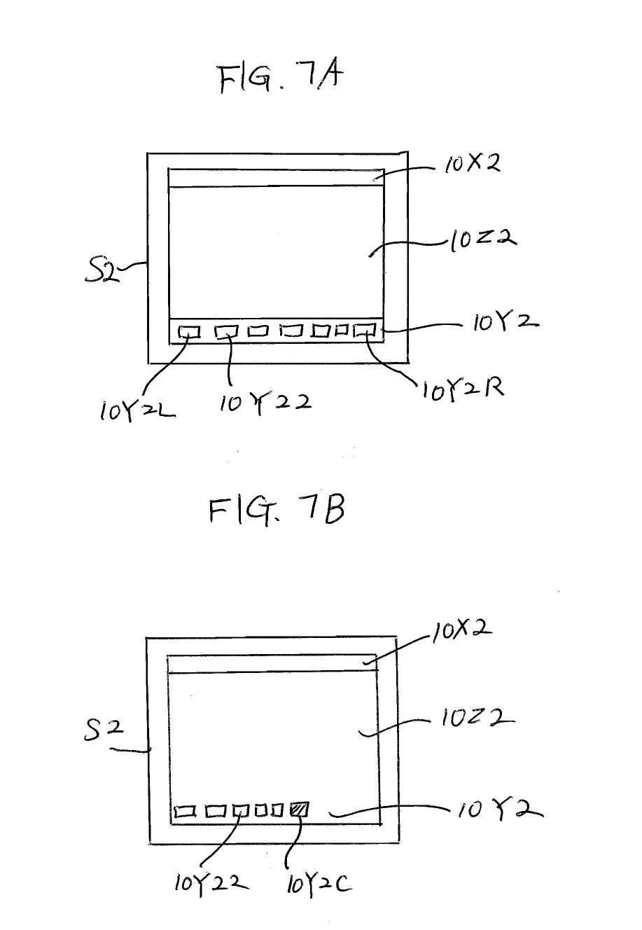

Referring to FIG. 7A, a left side menu 10y2L and a right side menu 10y2R are disposed opposite portions of the user input menu section 10y2. The user input menus 10Y22 may be disposed between the left side menu 10y2L and the right side menu 10y2R. When the right side menu 10Y2R is selected or touched, the control unit recognizes the selection of the right side menu 10Y2R as a user input or a signal corresponding to a rotation of the electronic apparatus and rearranges the user input menus 10Y22 to the left side S2 as illustrated in FIG. 7B. A return menu or restore menu 10Z2C may be disposed at one end of the user input menus 10Y22. When the return menu or restore menu 10Z2C is selected or touched, the control unit recognizes the selection of the return menu or restore menu 10Z2C and rearranges the user input menus 10Y22 to be disposed as illustrated in FIG. 7A.

When the left side menu 10Y2L is selected or touched, the control unit recognizes the selection of the left side menu 10Y2L as a user input or a signal corresponding to a rotation of the electronic apparatus and rearranges the user input menus 10Y22 to the right side S2 opposite to the left side S2 of FIG. 7B. A return menu or restore menu 10Z2C may be disposed at one end of the user input menus 10Y22. When the return menu or restore menu 10Z2C is selected or touched, the control unit recognizes the selection of the return menu or restore menu 10Z2C and rearranges the user input menus 10Y22 to be disposed as illustrated in FIG. 7A.

It is possible that the right side menu 10Y2R is selected or touched, the control unit recognizes the selection of the right side menu 10Y2R as a user input or a signal corresponding to a rotation of the electronic apparatus and rearranges the user input menus 10Y22 to the right side S2. And when the left side menu 10Y2L is selected or touched, the control unit recognizes the selection of the left side menu 10Y2L as a user input or a signal corresponding to a rotation of the electronic apparatus and rearranges the user input menus 10Y22 to the left side S2

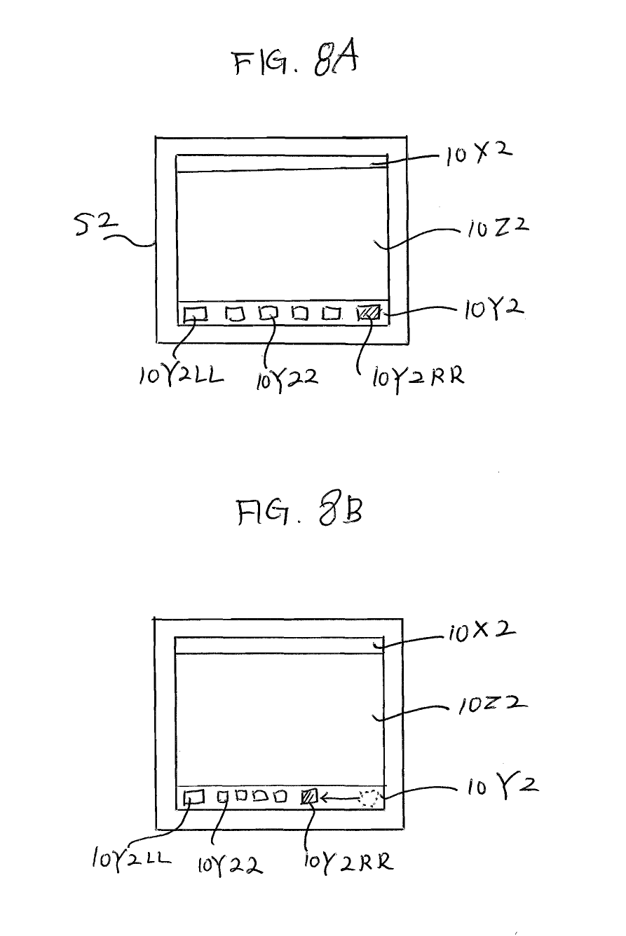

Referring to FIG. 8A, a user can drag a right side menu 10Y2RR toward a left side menu 10Y2LL, the control unit recognizes the movement of the right side menu 10Y2RR as illustrated in FIG. 8B as a rotation of the electronic apparatus, and rearranges the user input menus to the left side S2. It is possible that a user moves the left side menu 10Y2LL to the right side menu 10Y2RR, the control unit recognizes a movement of the left side menu 10YLL and controls the screen to dispose the user input menus to the right side S2.

It is also possible that a user can move the left side menu 10Y2LL by a first distance, and moves the right side menu 10Y2Rr by a second distance such that the user input menus can be disposed between the moved left side menu 10Y2LL and the moved right side menu 10Y2RR.

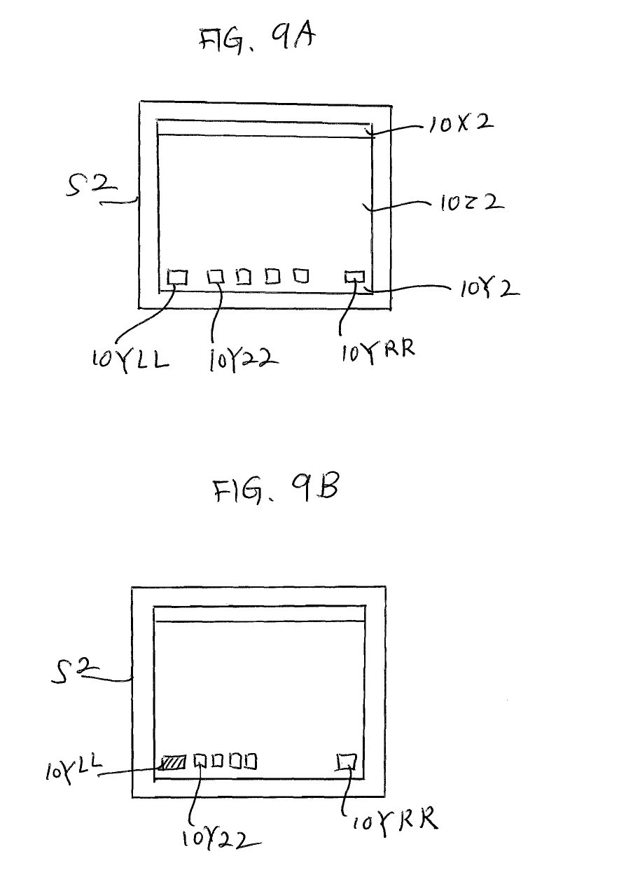

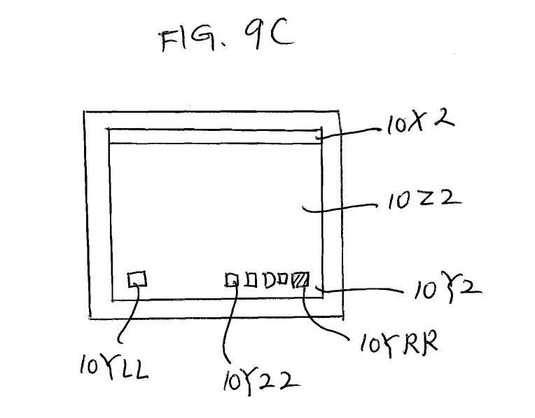

Referring to FIGS. 9A, 9B, and 9C, the user input menu section 10Y2 may include the left side menu 10Y2LL, the right side menu 10Y2RR, and user input menus 10Y22 disposed between the left side menu 10Y2LL, the right side menu 10Y2RR as illustrated in FIG. 9A. When the left side menu 10Y2LL is touched or selected, the user input menus 10Y22 are disposed closer to the left side menu 10Y2LL than the right side menu 10Y2RR as illustrated in FIG. 9B. When the right side menu 10Y2RR is touched or selected, the user input menus 10Y22 are disposed closer to the right side menu 10Y2RR than the left side menu 10Y2LL as illustrated in FIG. 9C.

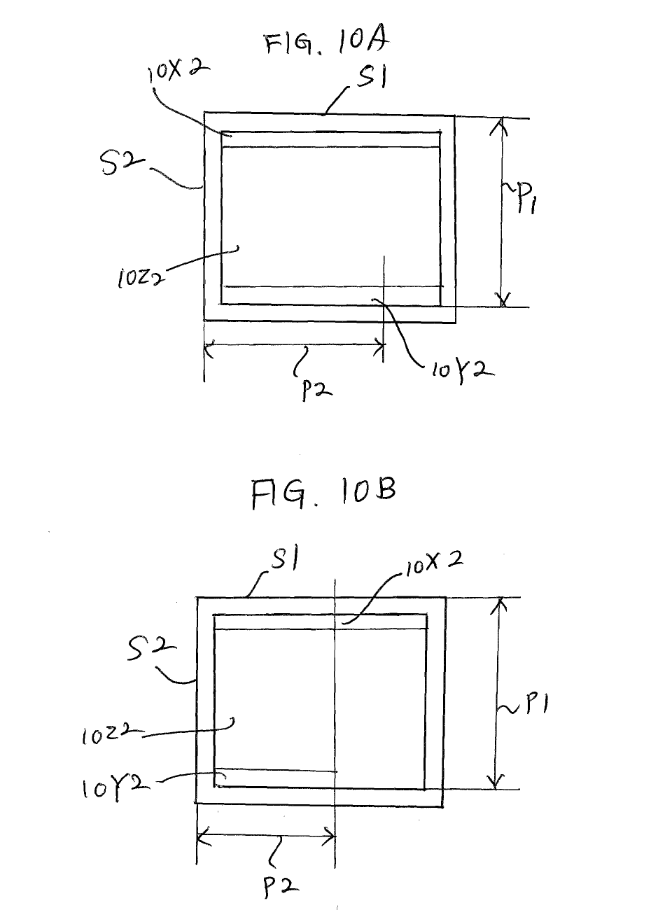

Referring to FIGS. 10A and 10B, when a distance from a side S1 to an end of the screen is P1, a distance from a side S2 to an end of the user input menu section 10Y2 may be P2. The distance P2 may be the same as the distance P1. However, when a user finger can reach a point from the side S1 or S2 more than the distance P1 or P2 because a size of dimension of the electronic apparatus is small, the distance P2 may be longer than the distance P1. It is possible that a user space 10Z3 can be formed on a side of the screen as illustrated in FIG. 10B. The user space 10Z3 can be usable as a deserved area which can be defined by a user according to a user preference. The user space 10Z3 may be used as a note area to enter a user note. The electronic apparatus may have an icon or menu to set up the user space 10Z3.

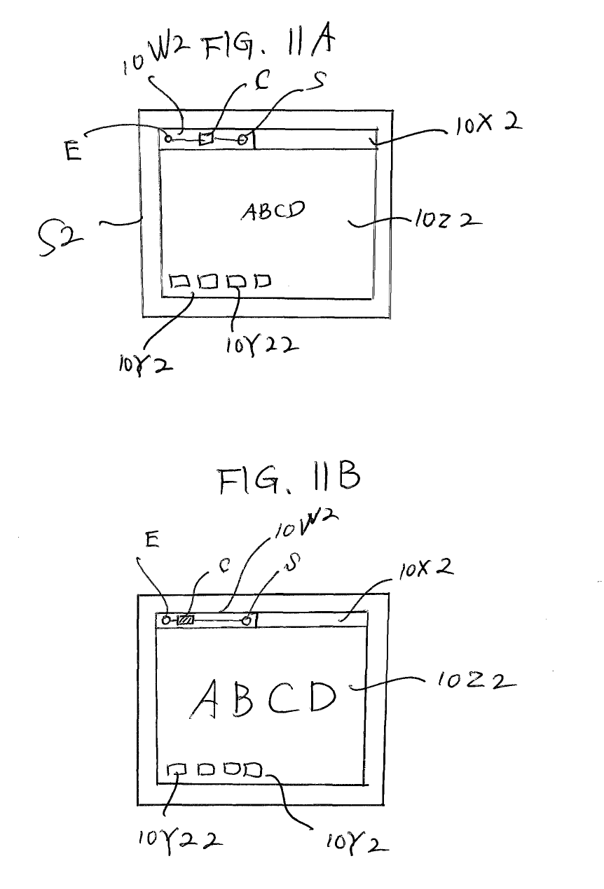

Referring to FIG. 11A, the control unit can adjust the non-user input menu section 10X2 such that a control menu section 10W2 can be disposed closer to the side S2. The control menu section 10W2 may include sub-menus E, S, and C. When a user moves a sub menu C toward the sub menu E, the control unit recognize the movement of the sub menu in a direction toward the sub menu E and controls an image or text of the main menu section 10Z2 to be enlarged as illustrated in FIG. 11B.

According to a distance between the sub menu C and at least one of the sub menus E and S, the control unit determines an amount of enlargement or diminishment of the image or text of the main menu section 10Z2.

Since the control menu section 10W2 is disposed on the side S2, a user can support the electronic apparatus and also control a characteristic of the image and text displayed in the main menu section 10Z2, with one hand.

Although FIGS. 11A and 11bB illustrate the control menu section 10W2 as the image or text enlargement or diminishment, the present general inventive concept is not limited thereto. The control menu section 10W2 may be a volume control, a brightness control, an image or text movement in a predetermined direction.

It is possible that the control menu of the control menu section 10W2 may be one of the user input menus.

The menus of a screen can be arranged or modified in location, size, dimension, characteristic, etc., according to a position (rotation) of the electronic apparatus such that a user can use one hand to support the apparatus and to select a menu or icon as a user input to control a function corresponding to the selected menu or icon.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include a read-only memory (ROM), a random-access memory (RAM), a flash memory, a semiconductor chip package, CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. An electronic apparatus comprising:
a display unit having a screen to display a screen image with a user input menu section with one or more user input menus to enter a user input to control one of the screen image and the electronic apparatus; and
a control unit to control the user input menu section of the screen image to be disposed closer to one side of the screen of the display unit than the other opposite side of the screen of the display unit.

2. The electronic apparatus of claim 1, wherein the control unit controls the screen image to be adjusted according to a rotation of the electronic apparatus.

3. The electronic apparatus of claim 2, further comprising:
a detecting unit to detect the rotation of the electronic apparatus,
wherein the control unit arranges the user input menus to be disposed closer to the one side than the other opposite side of the screen according to the detected rotation of the electronic apparatus.

4. The electronic apparatus of claim 1, wherein the control detects a user input and arranges the user input menus to be disposed closer to the one side than the other opposite side of the screen according to the detected rotation of the electronic apparatus.

5. The electronic apparatus of claim 1, further comprising:
a housing having first opposite sides having a first length and second opposite sides having a second length,
wherein the control unit controls the user input menu section of the screen image to be disposed closer to one of the first opposite sides and the second opposite sides than the other one of the first opposite sides and the second opposite sides.

6. The electronic apparatus of claim 1, further comprising:
a housing having first opposite sides having a first length and second opposite sides having a second length shorter than the first length,
wherein the control unit controls the user input menu section of the screen image to be disposed closer to one of the second opposite sides than the other one of the second opposite sides.

7. The electronic apparatus of claim 1, further comprising:
a housing having first opposite sides having a first length and second opposite sides having a second length,
wherein the screen image includes a non-user input menu section having one or more non-user input menus, and the control unit does not control the non-user input menu section to be disposed closer to any of the first opposite sides and the second opposite sides.

8. The electronic apparatus of claim 1, further comprising:
a housing having first opposite sides having a first length and second opposite sides having a second length,
wherein the screen image includes a main menu section having one or more main menus to receive a user input, and the control unit controls the main menu section to be disposed to closer to one of the first opposite sides and the second opposite sides.

9. The electronic apparatus of claim 1, further comprising:
a housing having first opposite sides having a first length and second opposite sides having a second length shorter than the first length, the screen disposed on the housing,
wherein the control unit controls the user input menu section to be disposed within a distance to correspond to the second length regardless of a rotation of the electronic apparatus.

10. The electronic apparatus of claim 1, further comprising:
a housing having first opposite sides having a first length and second opposite sides having a second length shorter than the first length,
wherein the screen image includes a main menu section having an image and a play button, and the control unit controls the play button of the main menu section to be disposed to closer to one of the first opposite sides and the second opposite sides to control the image of the main menu section.

11. A method of controlling an electronic apparatus comprising:
controlling a display unit having a screen to display a screen image with a user input menu section with one or more user input menus to enter a user input to control one of the screen image and the electronic apparatus; and
controlling the user input menu section of the screen image to be disposed closer to one side of the screen of the display unit than the other opposite side of the screen of the display unit.

12. The method of claim 11, wherein the controlling of the user input menu section comprises:
detecting a rotation of the electronic apparatus,
arranging the user input menus to be disposed closer to the one side than the other opposite side of the screen according to the detected rotation of the electronic apparatus.

13. The method of claim 11, wherein the controlling of the user input menus section comprises:
detecting a user input and arranging the user input menus to be disposed closer to the one side than the other opposite side of the screen according to the detected rotation of the electronic apparatus.

14. The method of claim 11, wherein:
the electronic apparatus includes a housing having first opposite sides having a first length and second opposite sides having a second length; and
the controlling includes controlling the user input menu section of the screen image to be disposed closer to one of the first opposite sides and the second opposite sides than the other one of the first opposite sides and the second opposite sides.

15. The method of claim 1, wherein:
the electronic apparatus includes a housing having first opposite sides having a first length and second opposite sides having a second length shorter than the first length; and
the controlling includes controlling the user input menu section of the screen image to be disposed closer to one of the second opposite sides than the other one of the second opposite sides.

16. The method of claim 1, wherein:
the electronic apparatus includes a housing having first opposite sides having a first length and second opposite sides having a second length;
the screen image includes a non-user input menu section having one or more non-user input menus; and
the controlling includes controlling the non-user input menu section to be disposed closer to any of the first opposite sides and the second opposite sides.

17. The method of claim 1, wherein:
the electronic apparatus includes a housing having first opposite sides having a first length and second opposite sides having a second length;
the screen image includes a main menu section having one or more main menus to receive a user input; and
the controlling includes controlling the main menu section to be disposed to closer to one of the first opposite sides and the second opposite sides.

18. The method of claim 1, wherein:
the electronic apparatus includes a housing having first opposite sides having a first length and second opposite sides having a second length shorter than the first length, the screen disposed on the housing; and
the controlling includes controlling the user input menu section to be disposed within a distance to correspond to the second length regardless of a rotation of the electronic apparatus.

19. The method of claim 1, wherein:
the electronic apparatus includes a housing having first opposite sides having a first length and second opposite sides having a second length;
the screen image includes a main menu section having an image and a play button; and
the controlling includes controlling the play button of the main menu section to be disposed to closer to one of the first opposite sides and the second opposite sides to control the image of the main menu section.

20. A non-transitory computer readable medium to contain computer readable codes as a program to execute the method of claim 11.
